(19) United States
(12) Patent Application Publication
(10) Pub. No.: US 2005/0281277 A1
(43) Pub. Date: Dec. 22, 2005

(54) Establishing traffic priorities in a voice over IP network

(76) Inventor: Thomas Joseph Killian, Westfield, NJ (US)

Correspondence Address: AT&T CORP., P.O. BOX 4110, MIDDLETOWN, NJ, 07748, US

(21) Appl. No.: 10/873,579

(22) Filed: Jun. 22, 2004

(51) Int. Cl. H04Q 11/00

(52) U.S. Cl. 370/412

(57) ABSTRACT

A method and apparatus for establishing traffic priorities in an IP network connected with multiple communication sources is disclosed. Different types of packets such as voice packets and data packets are received for transmission over a single network access link. In order to assure quality voice transmissions, voice packets are given priority over data packets by limiting a transmission rate from a data input queue whenever voice packets are detected in a voice input queue. Different combinations of interleaved voice and data packets help to alleviate packet congestion while maintaining priority for voice packets. In one aspect of the invention, priority for voice packets is further accomplished by limiting the size of data packet frames. In some instances when no voice packets are awaiting transmission, data packets are transmitted at a maximum rate in order to make full use of the network access link bandwidth. The invention is particularly beneficial when implemented over cable and DSL network access links with slow upstream feed rates.

### BACKGROUND OF THE INVENTION

This invention relates generally to Internet communications, and more particularly to priority schemes for transmitting packets from different communication sources across a packet switched network.

Successful transmission over the same IP connection of both synchronous content such as voice and asynchronous content such as data requires careful scheduling, particularly if the offered packet load from the asynchronous source can meet or exceed the network capacity. This creates the possibility of filling most of the network channel bandwidth with data packets, thereby delaying or disrupting transmission of real-time voice conversation packets. If undesirable latency (i.e., delay) for the voice packets is not ameliorated, then the quality of voice content received at a destination may be deficient or in the worst case fragmented, garbled or unintelligible.

For example, when one or more users initiate data traffic during a Voice over IP call, the data will interfere with the voice packets causing poor or disastrous voice quality at the listening destination. This problem is often a result of limited bandwidth in network access links such as cable and DSL that have slow upstream feed rates.

A solution is needed for Voice over IP communication systems that provides efficient use of network transmission links for both data and voice, while at the same time establishing predictable priority for voice transmissions.

### BRIEF SUMMARY OF THE INVENTION

A network access node is provided for receiving IP (internet protocol) packets from a plurality of sources through input queues on its LAN side and selectively controlling transmission of such IP packets through a single output queue on its WAN side, while at the same time maintaining priority for transmitting voice packets.

One aspect of the invention provides a method and apparatus for establishing a traffic priority scheme that favors voice packets over data packets. This priority scheme is preferably implemented in a home or business communication system such as a LAN having a smart access node coupled through an edge router to a WAN, thus eliminating the need for any special filtering properties in the network traffic generators. In order to assure quality voice transmissions, voice packets are given priority over data packets by limiting a transmission rate from a data input queue whenever voice packets are detected in a voice input queue.

In some embodiments of the invention, priority for voice packets is further accomplished by limiting the size of data packet frames.

The voice and data packets may be interleaved together for sending through a time division multiplexed transmission link in accordance with predetermined position guidelines that slow down the upstream data packet rate and speed up the upstream voice packet rate. Different combinations of interleaved voice and data packets help to alleviate packet congestion while maintaining priority for voice packets.

In certain instances where no voice packets are awaiting transmission, data packets may be transmitted at a maximum rate in order to make full use of the network access bandwidth.

The priority features of the invention are particularly beneficial when implemented in combination with network access links such as cable and DSL (digital subscriber line) that have slow upstream feed rates.

These and other advantages of the invention will be apparent to those of ordinary skill in the art by reference to the following detailed description and the accompanying drawings.

### BRIEF DESCRIPTION OF THE DRAWINGS

FIG. 1 shows a high level block diagram of a network access node configured to operate in accordance with the present invention.

FIG. 2 is a flow chart embodiment having features in accordance with the present invention.

FIG. 3 shows a schematic block diagram of another embodiment of the invention.

FIG. 4 shows a high level schematic diagram of an embodiment of the invention implemented in a WAN access node having more than one network access link for receiving packets from a plurality of voice terminals and data terminals incorporated in a LAN.

FIG. 5 is another flow chart embodiment of the invention.

FIG. 6 is a schematic representation of different exemplary upstream shared and non-shared operational states of the present invention for voice packets and data packets transmitted along a single network access link.

### DETAILED DESCRIPTION

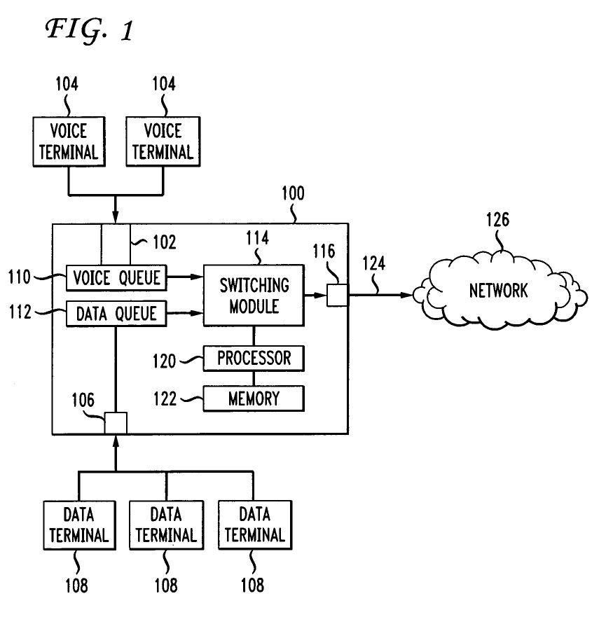

A high level block diagram of a network access node configured to operate in accordance with the present invention is shown in FIG. 1. Network access node 100 includes an input port 102 for receiving voice packets from at least one communication source such as one or more voice terminals 104, and also includes another input port 106 for receiving data packets from at least another communication source such as one or more data terminals 108. A voice queue 110 and a data queue 112 pass the voice packets and data packets, respectively, to a switching module 114 connected to an output port 116. The data queue 112 includes extra storage space for handling an excessive quantity of incoming data packets.

A processor 120 is shown connected to a memory 122 and to the switching module 114, and may also have direct or indirect connections to the voice queue 110, data queue 112, input ports 102, 106, output port 116 and buffer 118, in order to assure selective priority transmission of both voice and data packets through a single access link 124 to a network such as WAN 126. The processor controls the overall functioning of the network access node 100 by executing computer program instructions stored in memory 122. Although memory 114 is shown in FIG. 1 as a single element, memory 114 may be made up of different types of memory, such as random access memory (RAM), read-only memory (ROM), magnetic disk storage, optical disk storage, or any other type of computer storage. One skilled in the art will recognize that FIG. 1 is a high level functional diagram of a network access node configured to operate in accordance with the present invention. An actual network access node would have additional elements in order to perform all the function of a network access node, however such additional elements are not shown in FIG. 1 for clarity.

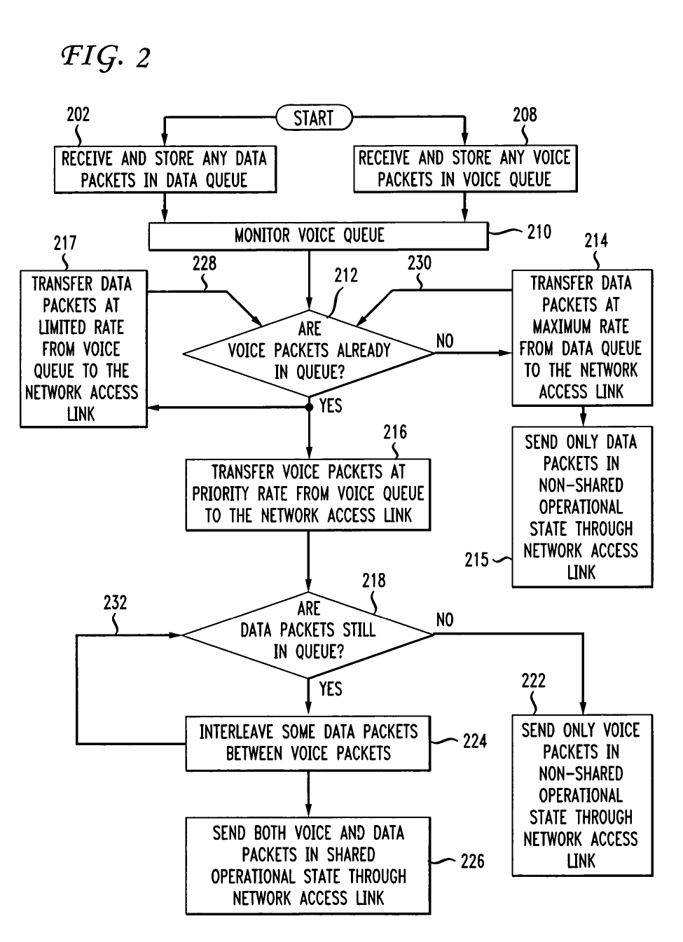

Referring to the exemplary flow chart of FIG. 2 showing operational steps for the embodiment of FIG. 1, data packets are received from data terminals 108 and temporarily stored in a data queue 112 (step 202). Voice packets are received from voice terminals 104 and are temporarily stored in a voice queue 110 (step 208). The voice queue is monitored (step 210) in order to determine whether any voice packets are already in the voice queue (step 212). If the voice queue 110 is empty and only data packets are waiting in an input queue, then data packets are transferred at a maximum rate (step 214) through the network access link 124 in a non-shared operational state (step 215). Such maximum rate is preferably the maximum bandwidth speed capability of the network access link 124.

When voice packets are detected in the voice queue 110, the voice packets are transferred at a predetermined priority rate (step 216) by the switching module 114 from the voice queue to the network access link 124, while at the same time data packets are transferred at a limited (i.e. lower) rate (step 217) by the switching module 114 from the data queue 112 to the network access link 124.

In this exemplary embodiment, the discretionary use of bandwidth by increasing or decreasing the transfer rate of data packets from the data queue 112 is accomplished. Thus when data packets are also waiting in an input queue (step 218), some data packets may be transferred at a limited lower rate in order to be interleaved between voice packets (step 224) in accordance with predetermined spacing guidelines for transmission through the network access link 124 in a shared operational state (step 226).

It will be understood from the foregoing description that the voice queue 110 is repeatedly monitored as indicated at 228, 230 in order to detect the presence of at least one voice packet waiting in the voice queue 110. Such voice packets are immediately given priority for transmission through the network access link in either the non-shared operational state 222 or the shared operational state 226. Also as indicated at 232, any data packets detected in the data queue 112 are transmitted through the network access link based on bandwidth availability. This enables the processor 120 and switching module 114 to coordinate transmission of voice and/or data packets in the most efficient operational state upstream through the network access link 124, while at the same time giving priority to the voice packets to assure satisfactory quality performance for Voice over IP telephone conversations.

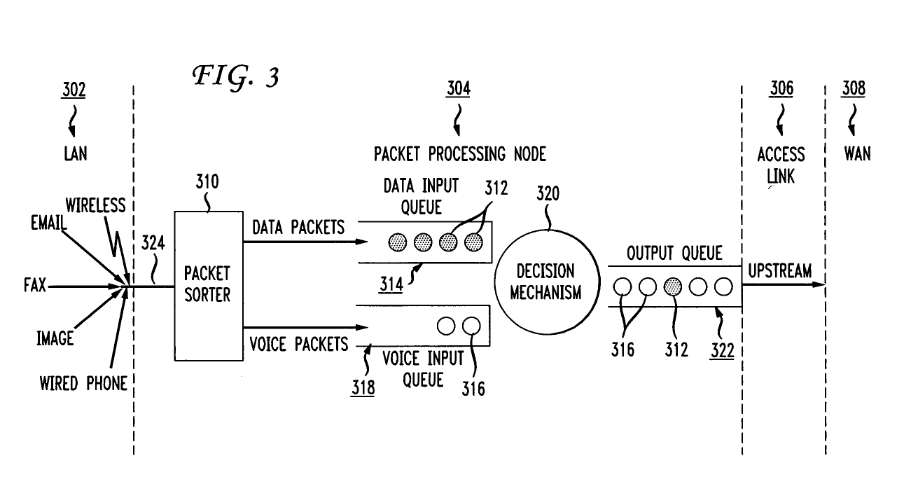

Referring to FIG. 3, a schematic diagram shows another embodiment of a network access node identified as packet processing node 304 implemented at an interface between a LAN (local area network) and a WAN (wide area network). A LAN 302 is connected through a packet processing node 304 and an upstream access link 306 to WAN 308 in accordance with an exemplary configuration of the present invention. The LAN 302 may include a variety of input packet transmissions such as wireless data, email, facsimile, image, wired phone, cordless phone, etc. The upstream access link 306 may include various types such as cable, dial-up, DSL, wireless, satellite, etc.

The packet processing node 304 includes a packet sorter 310 for directing data packets 312 into a data input queue 314 and directing voice packets 316 into a voice input queue 318. The packet sorter 310 may determine the type of incoming packet on a LAN channel 324 by detecting and recognizing its MAC address, type of service, IP header field, Diff Serve Code Point Marker, or identification flag. A decision mechanism 320 controls the rate and timing for transferring such packets into an output queue 322 in order to give priority to voice packets awaiting transmission from the voice input queue 318. It is to be understood that other combinations of components and techniques can be used for priority queuing and rate limiting in order to determine how the next packet (i.e., voice packet or data packet) is chosen from data and voice queues to send on the outgoing interface.

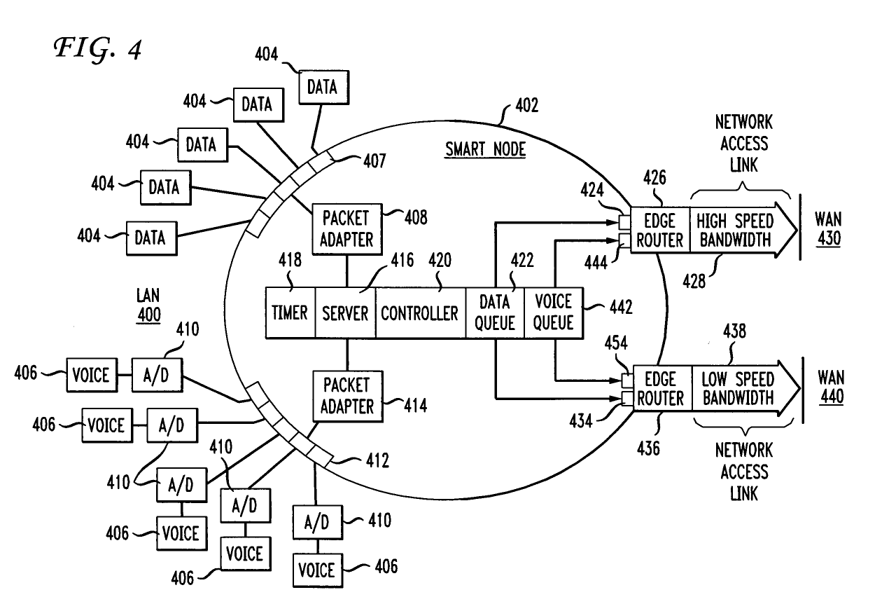

Referring to FIG. 4, another exemplary embodiment of the invention shows a LAN 400 having a smart node 402 that processes outgoing transmissions received from data sources 404 and voice sources 406. The data sources 404 are connected respectively through ports 406 to packet adapter 408, and the voice sources 406 are connected respectively through A/D converters 410 and ports 412 to packet adapter 414. A server 416, timer 418 and controller 420 work together to selectively process and transmit data packets from packet adapter 408 through data queue 422, port 424 and edge router 426 to network access link 428 that provides high speed bandwidth access to WAN 430. In this embodiment an alternate routing path for data packets is shown from packet adapter 408 through data queue 422, port 434 and edge router 436 to network access link 438 that provides low speed bandwidth access to WAN 440.

The server 416, timer 418 and controller 420 also selectively process and transmit voice packets from packet adapter 414 through voice queue 442, port 444 and edge router 426 to network access link 428. Thus both voice and data packets can be sent upstream in a shared or non-shared state through the same high speed network access link to WAN 430. As with the data packets, this embodiment shows an alternate routing path for voice packets from packet adapter 414 through voice queue 442, port 454 and edge router 436 to network access link 438. Thus both voice and data packets can be sent upstream in a shared or non-shared state through the same low speed network access link to WAN 440.

It will be understood by those skilled in the art that the packet processing components may be integral with or separately associated with the smart node 402, and that the particular smart node components and multiple network access links shown are for purposes of illustration only. Other implementations and combinations of various packet processing components may be incorporated with differently configured individual network access links in order to achieve the Voice over IP traffic priority benefits of the invention.

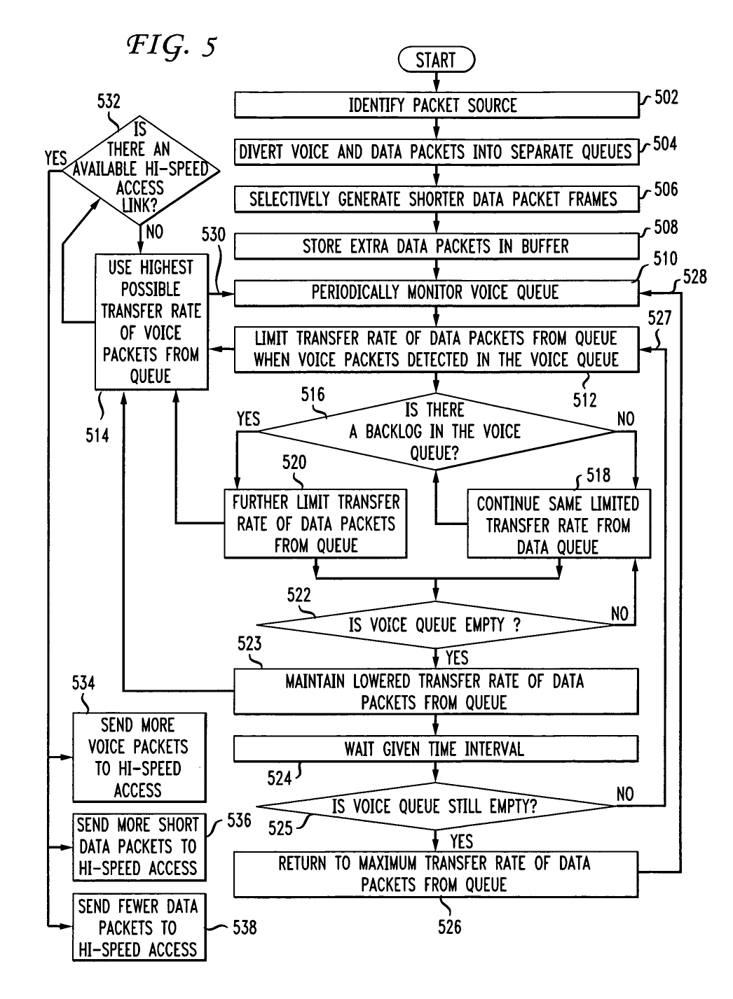

Referring to the exemplary flow chart of FIG. 5 showing operational steps for the embodiments of FIGS. 3 and 4, incoming packets are identified (step 502) such as by packet sorter 310 based on the type of origination terminal. As a result of such identification, voice and data packets are diverted (step 504) into separate queues. Extra data packets received at the data queue 422 are stored in a buffer memory (step 508) in order to give priority to voice packet transmissions.

In some embodiments data packets are translated into shorter frames (step 506). In an extreme case of limited bandwidth (e.g., 64 kb/second PCM voice over a 128 kb/second DSL line), it would be preferable to have 128-byte data packets. If a faster more typical access link bandwidth such as 512 kb/second is available, you can have larger size frames such as 1100-byte data packets. However it is to be noted that an Ethernet LAN allows a maximum data frame of 1500 bytes.

The voice queue 318, 442 is periodically monitored (step 510) by the smart node 402 or decision mechanism 320 to detect voice packets received from any of the voice terminals 406. When voice packets are detected, the transmission of data packets from the data queue 312, 422 is limited (step 512) so that immediate transmission of one or more voice packets at a highest possible transfer rate (step 514) can commence. It is to be noted that voice packets are generated at a rate determined by a voice coder (or coders, if there are multiple voice streams), so there is no discretionary capability for use of bandwidth for voice packets, as there would be for data packets. In other words, you can speed up an FTP (file transfer protocol) data packet transfer, but you cannot speed up a voice packet transfer by telling people that they may now talk faster.

An optional feature of the invention provides for a determination of a backlog of voice packets (step 516) in the voice queue 316, 442. This feature has particular benefits where the LAN 400 has a plurality of voice terminals 406 that feed into the same voice queue 442. If there is no backlog, transmission of data packets from the data queue 312, 422 continues at the same limited rate (step 518). If a backlog is detected, the data packet transfer rate is limited to even a lower rate (step 520). When the voice queue 318, 442 is determined to be empty (step 522), the current limited rate for data packet transfers is maintained (step 523) while waiting a predetermined time interval (step 524) as measured by timer 418 to accommodate expected additional incoming voice packets from any ongoing telephone conversation(s).

When the voice queue is detected to remain empty after the appropriate given time interval (step 525), then the transfer rate of data packets is returned to a higher default rate (step 526), which is preferably the maximum transfer bandwidth for an access link 306, 428, 438 to WANs 308, 430, 440 respectively. When the voice queue is not empty, the data packet transfer rate continues to be limited 527. During normal operation the voice queue continues to be periodically monitored 528, 530 in order to dynamically control the relative transfer rates of voice packets and data packets in a predictable manner through the same network access link.

As shown in FIG. 4, some embodiments may include multiple network access links 428, 438 for transmitting voice and data packets from a heavily populated LAN to one or more WANs 430, 440. Under such circumstances, congestion caused by multiple voice and data users being online at the same time can be minimized if one of the multiple network access links is a high speed access link 428 that is available (step 532). A congestion-activated dynamic algorithm may include instructions for sending more voice packets to the high speed access link (step 534), and/or sending more short data packet frames to the high speed access link (step 536), and/or sending fewer data packets to the high speed access link (step 538).

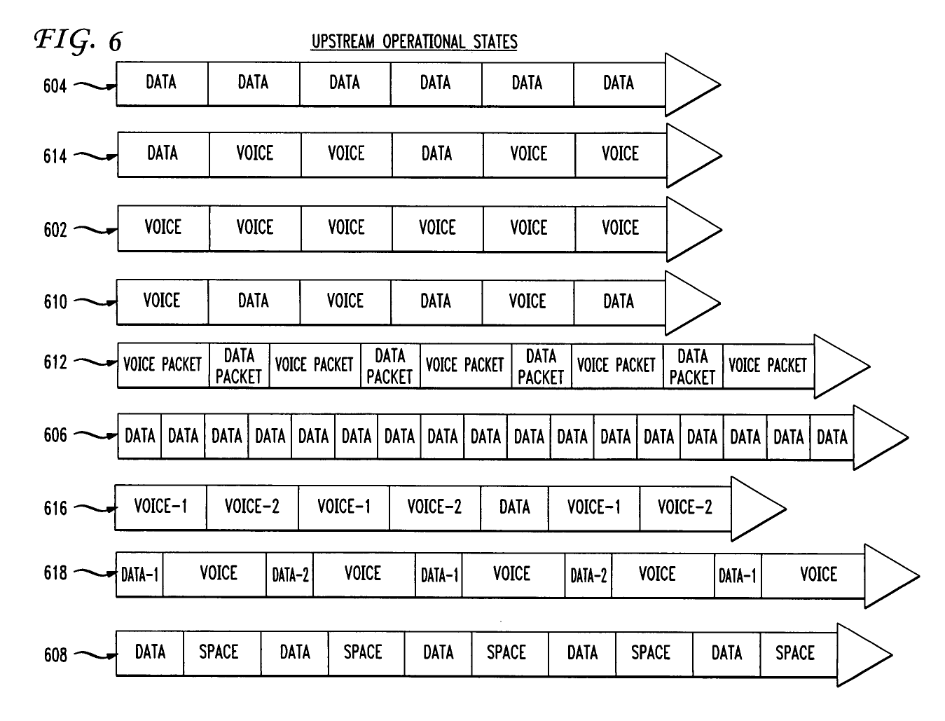

FIG. 6 is a schematic representation of various operational states showing possible combinations and sequences of packets transmitted upstream in time division multiplexed mode on a network access link. Of course, other combinations of differently sized packets can be arranged in order to give priority access to voice packets in accordance with the teachings of the present invention.

Examples of a non-shared operational state include voice packets only 602, data packets only 604 and short frame data packets only 606. An additional example of a hybrid non-shared operational state is shown at 608 wherein a space that could be occupied by other data packets remains vacant and available for voice packets immediately upon their arrival in the voice queue.

Examples of a shared operational state created by interleaving data packets with voice packets include alternating voice and data packets of similar size 610, alternating voice packets with short frame data packets 612, alternating two adjacent voice packets with a single data packet 614, alternating a sequence of four voice packets from multiple voice terminals with a single data packet 616, and alternating voice packets with short frame data packets from multiple data terminals 618.

It will be understood from the foregoing description that these patterns of interleaved data and voice packets created in accordance with the teachings of the invention can be predetermined as default patterns for a particular LAN sending specific types/length of packets through a given network access link having a certain available bandwidth speed. Alternatively these patterns of interleaved data and voice packets could be determined or modified dynamically in accordance with the teachings of the invention based on periodic monitoring of a voice queue as previously described.

A comparison of bandwidth rates between a typical Ethernet LAN and current network access links helps one to understand and appreciate certain features of the invention. As indicated in some of the previously described embodiments, IP packets from a plurality of user terminals enter through a network node to an edge router from the LAN side. There is usually enough capacity in the LAN to handle the offered load of outgoing packets, particularly in a 100 Mbit Ethernet LAN. Packets from all sources are to be sent out on the router's WAN side where bandwidth capacity is limited. In the case of a domestic DSL or cable modem subscriber, this capacity might be anywhere from 128 kbits/sec to 1 Mbit/sec.

The following detailed description for implementing certain invention features will be understood by those skilled in the art. In the exemplary embodiments, the priority queuing, rate limiting and MTU (maximum transmission unit) packet frame limiting may be implemented with Linux traffic shaping commands (‘tc qdisc . . . ’ and ‘tc filter . . . ’) and filtering (iptables) tools.

The command ‘tc qdisc . . . ’ sets up a hierarchy of queues with different priority and bandwidth parameters. When the output interface needs a packet to send, it probes the queues in priority order, and selects a packet from a queue whose bandwidth limit (if any) has not been exceeded. The command ‘tc qdisc . . . ’ thus governs how the queues are emptied.

The command ‘tc filter . . . ’ governs how the queues are filled, i.e., when a packet is received, to which queue should it go? The command ‘tc filter . . . ’ sets up a list of rules to make this decision for any given packet. Sometimes it is useful to base a decision on data that is not contained in the packet itself, e.g., the interface by which the packet entered the system. The iptables tools can be used to tag a packet with this sort of information.

The data queue may be rate-limited with a token-bucket filter. For example, imagine that a certain queue is associated with a ‘bucket’ containing ‘tokens’. The tokens arrive at a fixed rate, but the bucket has a fixed size, so that the tokens are discarded if the bucket is full. Now impose the following rule: if you want to take a packet from the queue, you must take a token from the bucket (so that if the bucket is empty, you must wait for a token). This scheme has the property that, averaged over a long period of time, the queue's bandwidth is limited to the token arrival rate, but, intermittently, the queue can have faster bursts, since several tokens might be available. The bucket size is a tunable parameter. In practice, you will probably collect more tokens for a large packet than for a small one.

Data packets enter the data queue at will, but are taken out at no more than a predetermined rate. Advantageously, the data queue has a large buffer limit such as 30 k bytes or more. This has the property that a TCP (transmission control protocol) connection is unlikely to suffer any data loss, but will instead see delay, and as a result, the well-known TCP slow-start mechanism will reduce throughput. Note that in the absence of rate limiting, a fast data producer in the LAN can swamp the available bandwidth in the network access link. The input data queue can be programmed to transmit a packet whenever asked, but the voice packet process is preferably programmed to transmit from the voice input queue only at the end of each sampling time interval.

The ‘sampling interval’ (see step 524 in FIG. 5) is determined by the voice codec, and is in the range of 20-50 milliseconds. The ‘monitoring interval’ (see step 510 in FIG. 5) is something like an estimated time between successive calls for a person who is always on the phone, probably a few seconds. The idea is that you don't want to go into a non-shared operational state too quickly, because another call might be imminent.

Once a packet is sent to the output queue hardware, bandwidth on the network access link is committed. However the output queue hardware will accept packets at a more or less infinite rate until its internal buffer is full. Note also that there is no reason for the rate limiting if no voice packets are being generated. So the decision mechanism can be programmed so that the rate limit on data packet transmission is not enforced if no voice packet has been seen for several seconds.

If the available outgoing bandwidth is small (e.g., less than 256 kbits/sec), then even a single maximal length Ethernet frame (MTU of 1514 bytes) may take long enough (approximately 50 msec) that the voice stream can be disrupted. IP packets can be fragmented into multiple Ethernet frames, but most NAT (network address translation) routers are unable to cope with IP fragmentation, because port numbers are present only in the first fragment. A less general, but more robust solution, is to reduce the TCP MSS (maximum segment size) so that large Ethernet frames are not generated. Shortening a packet frame for UDP (user datagram protocol) and other traffic would require a different implementation.

The foregoing Detailed Description is to be understood as being in every respect illustrative and exemplary, but not restrictive, and the scope of the invention disclosed herein is not to be determined from the detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

1. A method of establishing traffic priorities for multiple communication sources sending transmissions through a network access link to an IP network, comprising:
storing voice packets received from a first communication source in a first input queue to a network node;
storing data packets received from a second communication source in a second input queue to the network node; and
limiting a data packet transmission rate from said second input queue through the network access link in order to give priority to any of said voice packets already received and awaiting transmission from said first input queue.

2. The method of claim 1 which further comprises receiving said voice packets and said data packets at a LAN interface for transmission through the upstream network access.

3. The method of claim 2 wherein said voice and data packets are received by the LAN interface at a LAN transmission rate that is greater than a signal transmission rate of the upstream network access.

4. The method of claim 1 which further comprises storing said data packets in a temporary storage buffer associated with said second input queue.

5. The method of claim 1 which further comprises recognizing from which communication source said packets originate in order to direct voice packets to said first input queue.

6. The method of claim 5 which further comprises recognizing packets by one of the following: MAC address, type of service, IP header field, DiffServe Code Point Marker.

7. The method of claim 1 which further comprises giving priority to said voice packets by limiting the size of said data packets.

8. The method of claim 1 wherein said data packets are interleaved between voice packets in a predetermined sequential default pattern for transmission through the network access link.

9. The method of claim 1 wherein said data packets are interleaved between voice packets in a sequential pattern for transmission through the network access link, said sequential pattern being dynamically determined based on monitoring said voice queue.

10. The method of claim 1 which further includes periodically monitoring said voice queue to detect any voice packets already received and awaiting transmission from said voice queue.

11. A method of establishing priority for voice packets transmitted over an IP network, comprising:
receiving voice packets and/or data packets from multiple communication sources for transmission over a single network access node;
processing said data packets in a non-shared operational state at one transmission rate through said single network access node in the absence of receiving any voice packets; and
processing said data packets in a shared operational state at a reduced transmission rate through said single network access node when also receiving said voice packets in order to give priority to said voice packets.

12. The method of claim 11 which further comprises sending both said data packets and said voice packets upstream through said single network access node during said shared operational state.

13. The method of claim 12 which further comprises sending said voice packets at a faster rate than said data packets through said single network access node during said shared operational state.

14. The method of claim 11 wherein said network access node comprises one of the following access links: cable, dial-up, DSL, wireless, satellite.

15. The method of claim 11 which further includes giving priority to said voice packets by limiting the size of said data packets.

16. The method of claim 11 further including processing said data packets and said voice packets in a shared operational state through said network access node, wherein said data packets are interleaved between voice packets in a predetermined sequential default pattern.

17. The method of claim 11 further including processing said data packets and said voice packets in a shared operational state through said network access node, wherein said data packets are interleaved between voice packets in a sequential pattern that is dynamically determined based on monitoring said voice queue.

18. The method of claim 11 which further includes periodically monitoring said voice queue to detect any voice packets already received and awaiting transmission from said voice queue.

19. Apparatus for establishing traffic priorities for multiple communication sources sending transmissions through a network access link to an IP network, comprising:
monitoring means in communication with a first input queue to detect any voice packets received from a first communication source;
channel means for routing data packets into a second input queue from a second communication source; and
server means for selectively controlling transfer of said voice packets and said data packets into a network access link in order to give priority to said voice packets by limiting a data packet transmission rate from said second input queue to the network access link.

20. The apparatus of claim 19 further comprising a controller associated with said channel means, said controller generating shorter data packet frames to be received into said second input queue.

21. The apparatus of claim 19 further comprising a controller associated with said second input queue, said controller limiting a transfer rate of said data packets from said second input queue whenever any voice packet is detected in said first input queue by said monitoring means.

22. The apparatus of claim 19 wherein said server means causes said data packets to be transmitted upstream in a non-shared operational state through said network access link whenever an absence of any voice packets is detected in said first input queue by said monitoring means.

23. The apparatus of claim 21 wherein said controller interleaves a data packet between groups of multiple voice packets for time division multiplexed transmission upstream in a shared operational state through said network access link.

24. The apparatus of claim 21 wherein said controller interleaves a data packet between individual voice packets for time division multiplexed transmission upstream in a shared operational state through said network access link.

25. The apparatus of claim 19 wherein said first input queue receives voice packets from a plurality of communication sources.

26. The apparatus of claim 21 wherein said controller interleaves a data packet between voice packets, said data packet being shorter than said voice packets.

27. The apparatus of claim 21 wherein said first and second communication sources are incorporated in a LAN having a faster packet transmission rate than a packet transmission rate of the network access link.

28. The apparatus of claim 27 which further includes a plurality of network access links, one of which has a higher packet bandwidth speed than the others.
